(19) United States
(12) Patent Application Publication
(10) Pub. No.: US 2025/0382158 A1
(43) Pub. Date: Dec. 18, 2025

(54) IMPROVED POLE TONGS WITH INTEGRATED SAFETY FEATURE

(71) Applicant: Robert FERGUSON, Burnaby (CA)

(72) Inventor: Robert FERGUSON, Burnaby (CA)

(21) Appl. No.: 18/742,815

(22) Filed: Jun. 13, 2024

(51) Int. Cl. B66C 1/28

(52) U.S. Cl. CPC B66C 1/28

(57) ABSTRACT

There is provided improved pole tongs. The pole tongs may include a first tong and a second tong, each having proximal and distal ends, with the distal ends having a pole engagement device for engaging a pole and the proximal end having a device for engagement with a lifting device. The first and second tongs may be scissorily connected to one another between the respective proximal and distal ends so that the respective pole engagement devices engage the pole therebetween when the lifting device is operated. An attachment device may be attached to each of the first and to the second tongs and a safety connector may be provided that is connectable to the respective attachment devices and configured to hang below the engagement devices when the pole is engaged therein.

### FIELD OF THE INVENTION

The invention relates to the field of tools for linemen and loggers used to safely load and unload poles and logs on and off of trucks respectively.

### BACKGROUND OF THE INVENTION

To safely load and unload poles and logs onto trucks is an integral part of the telecommunication, hydroelectric and logging industries.

The use of pole tongs to move poles or logs onto trucks is a practice undertaken by many workers in various industries. However, the current process requires workers to first balance the pole in the pole tongs, and then attach separate chains during subsequent steps to properly load poles and logs onto trucks.

A known issue with pole tongs is that the tongs are anchored into the pole by the weight that the pole exerts on the teeth that pierce the sides of the pole. If weight is removed from the teeth by having a pole touch down on one end or become unbalanced, the pole tong's teeth disengage from the pole, causing the pole or log to fall in unpredictable ways that result in damage to equipment and injury or death to workers.

Accordingly, a need exists for pole tongs that incorporate a safety device that prevents poles from being released by pole tongs and falling in an unpredictable manner.

### SUMMARY OF THE INVENTION

The following application relates to improved pole tongs that integrate a safety device as part of the design. The improved pole tongs can be used to safely move hydro poles, as well as logs.

The improved pole tongs integrate a safety device into traditional pole tongs. The improved pole tongs are forced closed by the safety device when the end of a pole or log touches down thus relieving weight from the teeth that cause the tongs to engage with the pole or log. A known safety concern with using pole tongs is that a pole or log must be balanced in the tongs when using them to move logs onto a truck bed. Pole tongs can be used in conjunction with other chains; however, when chains are not used, should weight come off the tongs, the tongs will open and release the pole or log causing it to fall onto equipment or unsuspecting workers. The use of other chains and tongs simultaneously is problematic as it requires workers to switch between the two devices, and workers may become complacent and not attach chains.

The new pole tongs integrate a safety mechanism that catches the pole and the weight of the pole forces the pole tongs shut by exerting force in a downward motion via the attachments on the pole tongs. This re-engages the pole tongs grip and prevents the pole or log from falling on equipment or workers.

According to the present invention, there is provided improved pole tongs. The pole tongs may include a first tong and a second tong, each having proximal and distal ends, with the distal ends having a pole engagement device for engaging a pole and the proximal end having a device for engagement with a lifting device. The first and second tongs may be scissorily connected to one another between the respective proximal and distal ends so that the respective pole engagement devices engage the pole therebetween when the lifting device is operated. An attachment device may be attached to each of the first and to the second tongs and a safety connector may be provided that is connectable to the respective attachment devices and configured to hang below the engagement devices when the pole is engaged in said teeth.

The attachment device may be a carabiner that is welded to each tong or designed as part of a unitary structure of the tong itself.

The safety connector may be a chain, strap or cable.

The pole engagement device may be a tooth at the distal end of each tong.

### BRIEF DESCRIPTION OF THE DRAWINGS

FIG. 1 is a side elevation view of an improved pole tongs in a closed position with a safety connector attached to an attachment device.

FIG. 2 is a partial perspective view of the improved pole tongs.

FIG. 3 is a side elevation view of the improved pole tongs in an open position without the safety connector.

### DESCRIPTION OF THE PREFERRED EMBODIMENT OF THE INVENTION

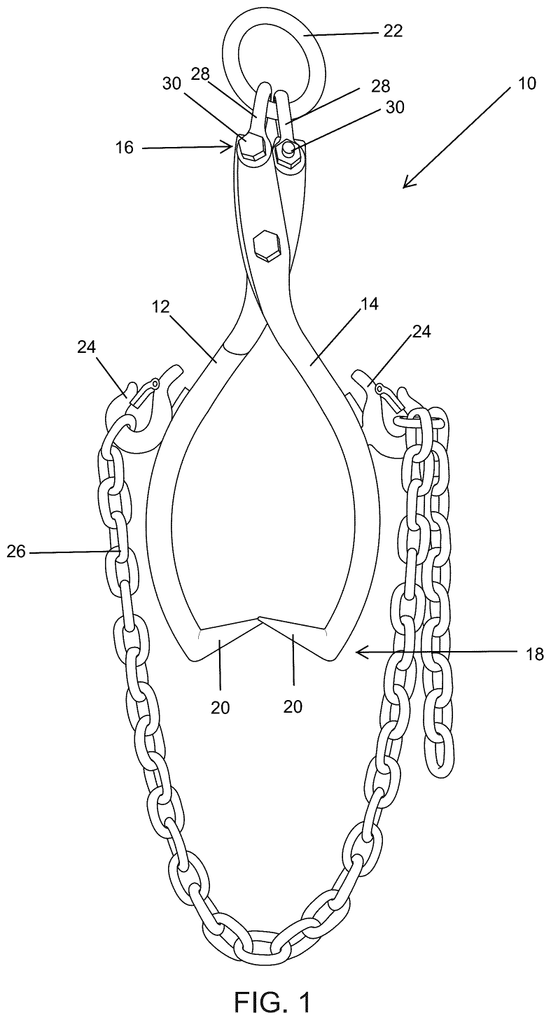

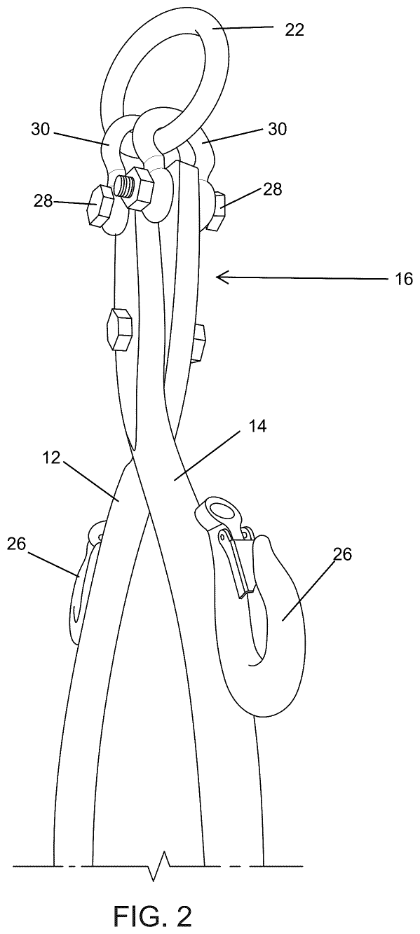

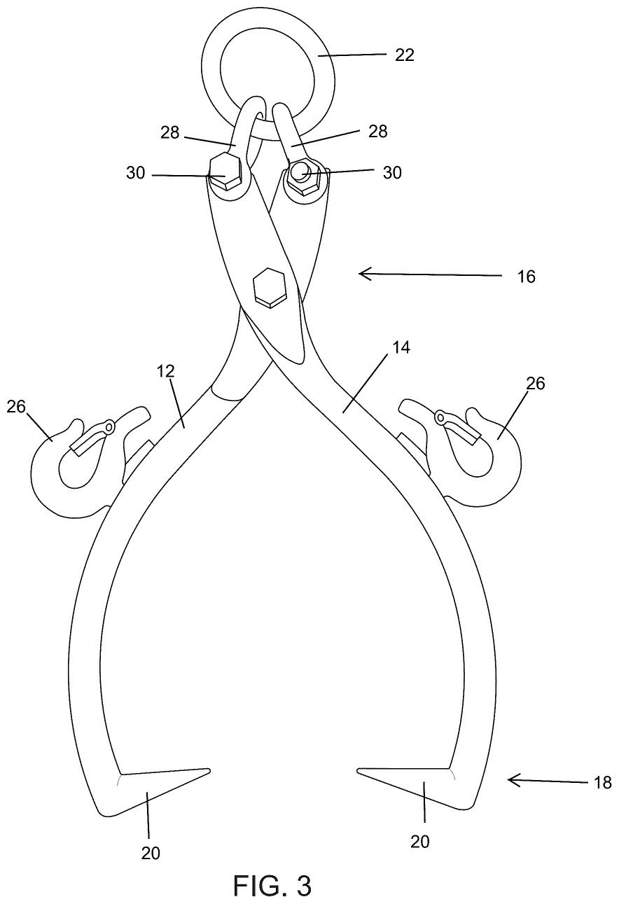

Referring to FIGS. 1 to 3, there is shown improved pole tongs 10. The pole tongs 10 includes a first tong 12 and a second tong 14. Each tong has proximal 16 and distal 18 ends, with the distal ends having a pole engagement device 20 for engaging a pole and the proximal end having a device 22 for engagement with a lifting device (not illustrated). The first 12 and second tongs 14 are scissorily connected to one another between the respective proximal 16 and distal 18 ends so that the respective pole engagement devices 20 engage the pole therebetween when the lifting device is operated. An attachment device 24 is attached to each of the first 12 and to the second 14 tongs and a safety connector 26 is provided that is connectable to the respective attachment devices 24 and is configured to hang below the pole engagement devices 20 when the pole is engaged therein.

The pole engagement device 20 is preferably a tooth at the distal 18 end of each tong. As those skilled in the art will appreciate the pole engagement device 20 may be any suitable device that is operable to connect and hold onto the pole. In the preferred embodiment, engagement device 20 and distal end 18 are a unitary structure.

The device 22 for engaging with a lifting device is preferably a ring attached to the proximal end of each tong by horseshoe shaped connectors 28 that are attached to the proximal end of the tongs by pin bolts 30. In the preferred embodiment, the horseshoe shaped connectors 28 can move along the circumference of the device 22, allowing the improved pole tongs to open and close.

The attachment device 24 is preferably a carabiner as shown in the figures, but as those skilled in the art will appreciate, any device may be used to attachably connect the safety connecter 26 to the tongs 12 and 14. In the preferred embodiment and as depicted, the safety connector 26 is a chain, but as those skilled in the art will appreciate, any connector with sufficient tensile strength, such as a chain, strap, belt, rope, cable, or the like will do.

### Operation

As the lifting device moves into position over a pole to be lifted, the safety connecter 26 is unattached from one or both of the attachment devices 24. The logger will then lower the tongs 12 and 14 into position onto the pole and manually engage the teeth 20 to the sides or underside of the pole. Once the teeth are suitably engaged, the logger will then wrap the safety connector 20 underneath the pole and then attach the safety connecter to the attachments devices 24 on each tong ensuring safety connector 26 is as tight to the pole as possible.

To lift the pole, the logger operates the lifting device to lift the ring 22 which then further engages tongs 12 and 14 around the pole. When transporting the pole with the lifting device, if weight is removed from the teeth 20 by having a pole touch down or become unbalanced, the teeth may disengage from the pole. However, with the safety connector 26 wrapped around the pole and onto the tongs 12 and 14 via attachment devices 24, pole disengagement is not possible, thus ensuring the safety of all workers.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

1. Improved pole tongs comprising:
a first tong comprising proximal and distal ends, said distal end comprising pole engagement means for engaging a pole and said proximal end comprising lifting engagement means for engaging a lifting device;
a second tong comprising proximal and distal ends, said distal end comprising pole engagement means for engaging the pole and said proximal end comprising lifting engagement means for engaging the lifting device, wherein said first and second tongs are scissorily connected to one another between said respective proximal and distal ends so that said respective pole engagement means engage the pole therebetween when the lifting device is operated;
attachment means attached to each of said first and to said second tongs; and
a safety connector connectable to said respective attachment means and configured to hang below said pole engagement means when the pole is engaged in therein pole engagement means.

2. The improved pole tongs of claim 1 wherein said attachment means comprises a carabiner.

3. The improved pole tongs of claim 2 wherein said carabiner is unitarily formed with said first and second tongs.

4. The improved pole tongs of claim 1 wherein said safety connector comprises a chain, strap, or cable.

5. The improved pole tongs of claim 1 wherein said pole engagement means comprises a tooth at the distal end of each tong.
